(19) United States
(12) Patent Application Publication
(10) Pub. No.: US 2012/0109773 A1
(43) Pub. Date: May 3, 2012

(54) METHOD AND SYSTEM FOR IMPLEMENTING BAR CODES WITH ONLINE AUCTIONS

(75) Inventors: Aaron Sipper, Alexandria, VA (US); Robert Durst, Dunstable, MA (US)

(73) Assignee: NeoMedia Technologies, Inc., Dunwoody, GA (US)

(21) Appl. No.: 13/076,135

(22) Filed: Mar. 30, 2011

Related U.S. Application Data
(60) Provisional application No. 61/322,323, filed on Apr. 9, 2010.

(51) Int. Cl. G06Q 30/08

(52) U.S. Cl. 705/26.3

(57) ABSTRACT

A method of and system for scanning a bar code associated with a product with a mobile device to obtain (i) a list of online auctions for the product or a similar product; (ii) a list of commercial web sites in which the product or a similar product is being offered for sale; and/or (iii) a list of resellers of the product or a similar product where the product or similar product is located in a geographic region in predetermined proximity to the location. In addition, a seller may scan a bar code associated with a product that the seller would like to sell via an online auction service in order to obtain a predetermined product listing that the seller may modify prior to listing on the online auction service.

### CROSS-REFERENCE TO RELATED APPLICATIONS

This application claims the benefit of U.S. provisional application No. 61/322,323 filed Apr. 9, 2010.

### TECHNICAL FIELD

This invention relates to machine readable codes, and in particular to a method of and system for scanning a bar code associated with a product with a mobile device to obtain (i) a list of online auctions for the product or a similar product, (ii) a list of commercial web sites in which the product or a similar product is being offered for sale, and/or (iii) a list of resellers of the product or a similar product; where the product or similar product is located in a geographic region in predetermined proximity to the location. In addition, a seller may scan a bar code associated with a product that the seller would like to sell via an online auction service in order to obtain a predetermined product listing that the seller may modify prior to listing on the online auction service.

### BACKGROUND ART

Online auction services exist on the Internet that enable users to either (1) purchase products or (2) sell products. In the case of product purchases, users often desire to be able to comparison shop for a product of interest. Rather than typing in a product description on a computer in order to obtain web sites where the product may be sold, and then typing in the product description again on a computer in order to obtain a list of auctions for that product, and then typing in the product description again on a computer in order to obtain a list of resale situations (such as CRAIGSLIST.ORG) for that product, it would be desired to have an automated system for finding this product purchase information.

In the case of a seller wanting to sell a product on an auction site such as EBAY, the seller usually has to generate a long detailed product listing to submit to the auction site. Here it would be desired to have an automated system for providing this product sale information.

### SUMMARY OF THE INVENTION

The present invention is a method of and system for providing a mobile shopping platform. In one aspect of the invention, a user desires to purchase a product, perhaps one he is considering purchasing at a store but would like to determine if he could obtain it less expensively at a different location or online. In this first aspect of the invention, the purchaser uses a mobile device to capture an image of a bar code symbol associated with a product the purchaser desires to purchase. The mobile device also acquires location information from a location reference (such as via GPS), the location information being indicative of the location of the mobile device (and the purchaser). The mobile device transmits the bar code data from the captured image of the bar code symbol and the location information to an online auction server computer, which then processes the bar code data to identify the product. The online auction server computer returns to the mobile device information associated with the product, which includes one or more of (i) a list of online auctions for the product or a similar product, (ii) a list of commercial web sites in which the product or a similar product is being offered for sale, and/or (iii) a list of resellers of the product or a similar product; where the product or similar product is located in a geographic region in predetermined proximity to the location. The mobile device displays to the purchaser the information received from the online auction server computer. The purchaser may then execute additional searches of the product or a similar product using the information returned from the online auction server computer, and he or she may execute a purchase transaction using the information returned from the online auction server computer.

In an alternative embodiment, a gateway service is used to help mediate the identification of the product from the bar code information. In this embodiment, the purchaser uses a mobile device to capture an image of a bar code symbol associated with a product the purchaser desires to purchase. The mobile device also acquires location information from a location reference (such as via GPS), the location information being indicative of the location of the mobile device. The mobile device transmits bar code data from the captured image of the bar code symbol and the location information to a gateway server computer, which then processes the bar code data and returns to the mobile device a URL associated with the product. The mobile device executes an online auction application to use the URL to query an online auction server computer for information associated with the product, which includes one or more of: (i) a list of online auctions for the product or a similar product, (ii) a list of commercial web sites in which the product or a similar product is being offered for sale, and/or (iii) a list of resellers of the product or a similar product; where the product or similar product is located in a geographic region in predetermined proximity to the location. The mobile device then displays to the purchaser the information received from the online auction server computer, and he or she may execute a purchase transaction using the information returned from the online auction server computer.

In this embodiment, the gateway server computer processes the bar code data in one of two possible ways. First, the gateway server computer may use an external resolution service by analyzing the bar code data to determine which of a plurality of resolution server computers is associated with the bar code data. The gateway server computer transmits the bar code data to the resolution server computer determined to be associated with the bar code data. The resolution server receives the bar code data from the gateway server computer and resolves the bar code data to a URL associated with the product. The resolution server computer then transmits the URL to the gateway server computer. In the second manner of processing the bar code data, the gateway server computer resolves the bar code data internally to a URL associated with the product without reliance on an external service.

In a second aspect of the invention, a user desires to sell a product via an online auction service. In order to generate an online auction listing for that product, the seller uses a mobile device to capture an image of a bar code symbol associated with a product he desires to sell in an online auction. The mobile device also acquires location information from a location reference (such as GPS), the location information indicative of the location of the mobile device (and the seller). The mobile device transmits the bar code data from the captured image of the bar code symbol and the location information to an online auction server computer. The online auction server computer processes the bar code data to identify the product and returns to the mobile device predetermined listing information associated with the product. The mobile device uses the predetermined listing information associated, with the product to generate an online auction listing for the product, which includes the product location information. The seller may optionally modify the predetermined information in the online auction listing. The mobile device then transmits the online auction listing for the product to the online auction server computer, and the online auction server computer operates an online auction in association with a plurality of auction client computers that bid for the purchase of the product from the seller in accordance with the online auction listing generated by the mobile device.

In an alternative embodiment, a gateway service is used to help mediate the identification of the product from the bar code information. In this embodiment, the seller uses a mobile device to capture an image of a bar code symbol associated with a product the seller desires to sell in an online auction. The mobile device also acquires location information from a location reference, the location information indicative of the location of the mobile device. The mobile device transmits bar code data from the captured image of the bar code symbol to a gateway server computer. The gateway server computer processes the bar code data and returns to the mobile device a URL associated with the product. The mobile device executes an online auction application to use the URL to query an online auction server computer for predetermined information associated with the product. The mobile device uses the predetermined information associated with the product to generate an online auction listing for the product, the online product listing including the product location information. The seller may optionally modify the predetermined information in the online auction listing. The mobile device transmits the online auction listing for the product to the online auction server computer, and the online auction server computer operates an online auction in association with a plurality of auction client computers that bid for the purchase of the product from the seller in accordance with the online auction listing generated by the mobile device.

In this embodiment, the gateway server computer processes the bar code data in one of two possible ways. First, the gateway server computer may use an external resolution service by analyzing the bar code data to determine which of a plurality of resolution server computers is associated with the bar code data. The gateway server computer transmits the bar code data to the resolution server computer determined to be associated with the bar code data. The resolution server receives the bar code data from the gateway server computer and resolves the bar code data to a URL associated with the product. The resolution server computer then transmits the URL to the gateway server computer. In the second manner of processing the bar code data, the gateway server computer resolves the bar code data internally to a URL associated with the product without reliance on an external service.

### BRIEF DESCRIPTION OF THE DRAWING

FIG. 1 is a block diagram of the system for implementing the first aspect of the invention in which a user wishes to purchase a product utilizing a mobile device.

FIG. 2 is a block diagram of the system for implementing the second aspect of the invention in which a user wishes to sell a product utilizing a mobile device.

FIG. 3 is a flowchart that illustrates the operation of the method of the first aspect of the invention.

FIG. 4 is a flowchart that illustrates the operation of the method of the first aspect of the invention.

### DETAILED DESCRIPTION OF THE PREFERRED EMBODIMENTS

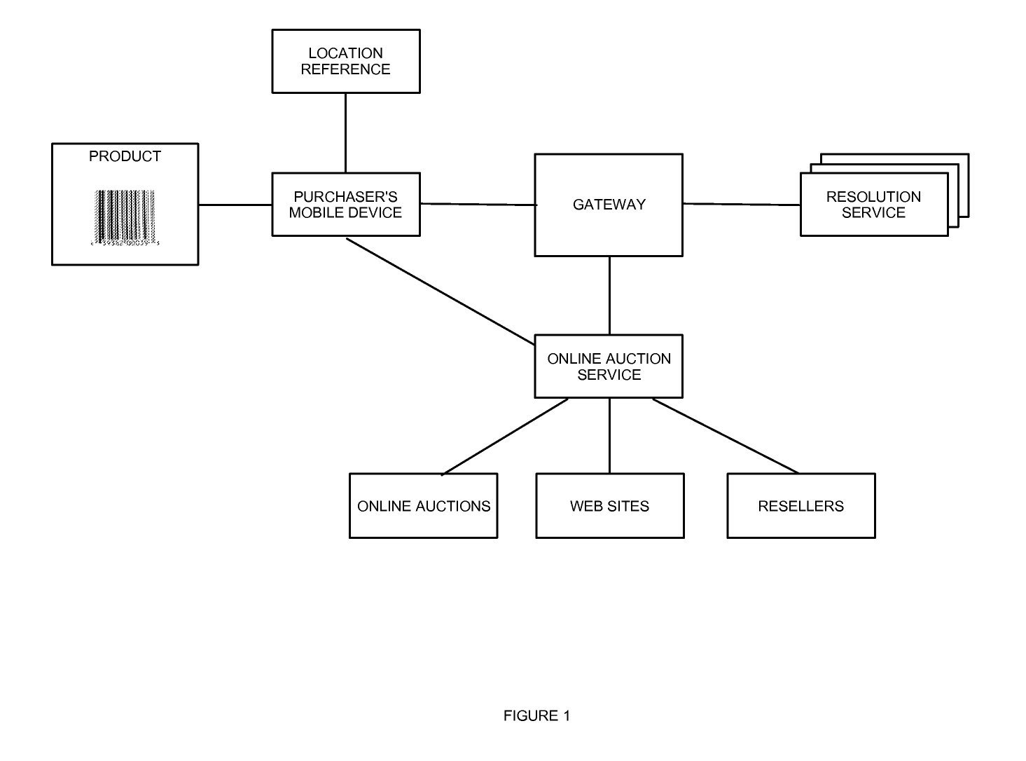

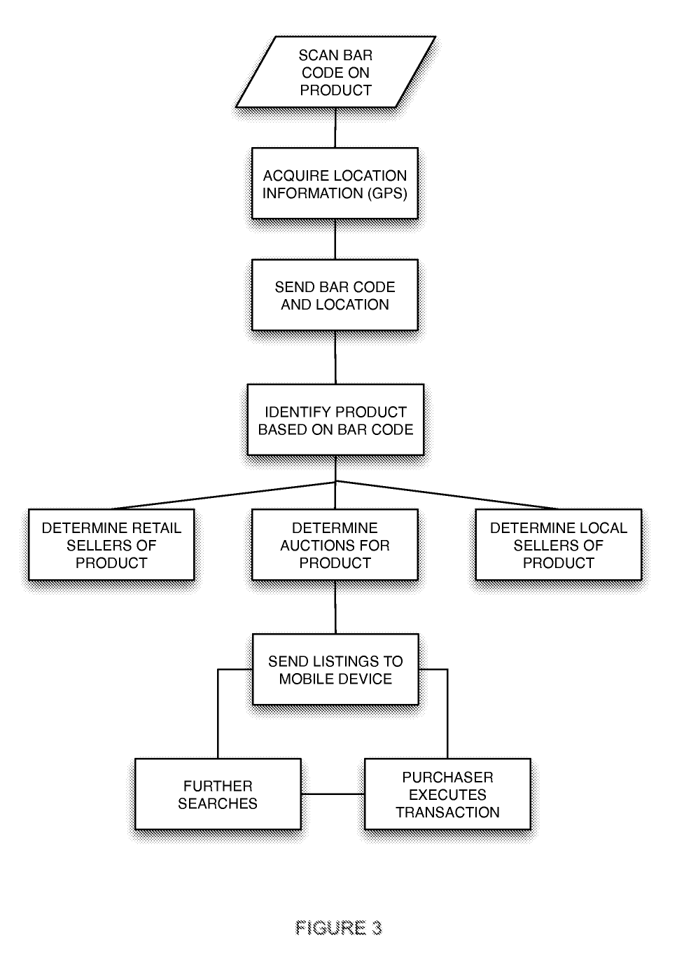

A detailed description of the preferred embodiments will now be described. The present invention is a method of and system for providing a mobile shopping platform for either purchasing or selling products. In one aspect of the invention, with respect to FIGS. 1 and 3, a user desires to purchase a product, perhaps one he is considering purchasing at a store but would like to determine if he could obtain it less expensively at a different location or online. In this first aspect of the invention, the purchaser uses a mobile device such as an IPHONE or the like to capture an image of a bar code symbol associated with the product that the purchaser desires to purchase. Although the preferred embodiment is describe with respect to a mobile device, a stationary or tethered device may also be used within the spirit and scope of the invention. The bar code may be found on the product itself, or on its packaging, or on an advertisement of the product, etc. Typically the bar code would be a UPC code prevalent in commerce today, although this invention may be adapted to work with any type of bar code that can be imaged and decoded with the mobile device running appropriate software as well known in the art.

The mobile device also acquires location information from a location reference, the location information being indicative of the location of the mobile device (and of the product and the user). The location reference may for example by a GPS system, wherein the mobile device has appropriate GPS built in or connected thereto. For example, the IPHONE has a GPS receiver built in, and can easily provide the GPS coordinates of the mobile device to any software application that is executing on the device. Alternative location determining systems may also be used, such as cell phone tower or wi-fi network triangulation and the like.

The mobile device transmits the bar code data from the captured image of the bar code symbol and the location information to an online auction server computer, which then processes the bar code data to identify the product. The bar code data may be decoded on the mobile device, or it may be sent in an undecoded format to the online auction server computer for decoding thereon as well known in the art. The online auction server computer may be operated by an online auction company such as EBAY or the like.

The online auction server computer processes the bar code data to determine the identification of the product that was scanned by the purchaser. This may be done by using a simple lookup table commonly used in commerce, where the UPC code is used to retrieve information about the associated product (such as price, description, manufacturer, etc.). This type of database is commercially available and may be located internal to the online auction server computer or it may be accessed via a network connection. Once the online auction server computer obtains information about the product that was scanned, it then uses that information to obtain further information about purchasing the product that will be of interest to the purchaser. Several types of information are collated as follows.

The first type of information obtained is a list of online auctions for the product or a similar product. For example, if the purchaser had scanned a bar code imprinted on the box of a SAMSUNG DVD player, the online auction server computer will review its database (and perhaps external databases) to find auctions that are being offered for that SAMSUNG DVD player as well as for similar products such as a SONY DVD player or a SHARP DVD player, or perhaps for a SAMSUNG BLU-RAY player.

The second type of information obtained is a list of commercial web sites in which the product or a similar product is being offered for sale. For example, a web search may be executed that determines that the SAMSUNG DVD player is being currently sold by on BESTBUY.COM, SEARS.COM, and RADIOCHACK.COM. Optionally, the location information acquired by the mobile device and sent to the online auction service will assist the online auction service in finding only those commercial web sites for which the product of interest is in stock in a geographic region in predetermined proximity to the location of the purchaser, such as within 5 miles (which can be modified by the user as desired).

The third type of information obtained is a list of resellers of the product or a similar product where the product or similar product is located in a geographic region in predetermined proximity to the location. For example, a search of a service such as CRAIGSLIST may determine that the same product is being sold by located someone 2 miles from the purchaser, as determined by the GPS data of the mobile device.

All of this information—the auction listings, commercial web sites, and reseller listings—is then sent back to the mobile device, which displays to the purchaser the information received from the online auction server computer. The purchaser may then execute additional searches of the product or a similar product using the information returned from the online auction server computer, and he or she may execute a purchase transaction using the information returned from the online auction server computer.

In an alternative embodiment, a central gateway service is used to help mediate the identification of the product from the bar code information rather than using a UPC lookup at the online auction server computer. In this embodiment, the mobile device transmits bar code data from the captured image of the bar code symbol and the location information to a gateway server computer, which then processes the bar code data and returns to the mobile device a URL associated with the product. The URL may be obtained in one of two possible ways as described below. The mobile device then executes an online auction application to use the URL to query the online auction server computer for information associated with the product that was described above (one or more of: (i) a list of online auctions for the product or a similar product; (ii) a list of commercial web sites in which the product or a similar product is being offered for sale; and/or (iii) a list of resellers of the product or a similar product where the product or similar product is located in a geographic region in predetermined proximity to the location). The mobile device then displays to the purchaser the information received from the online auction server computer, and he or she may execute a purchase transaction using the information returned from the online auction server computer.

As stated above, the gateway server computer processes the bar code data in one of two possible ways. First, the gateway server computer may use an external resolution service by analyzing the bar code data to determine which of a plurality of resolution server computers is associated with the bar code data. That is, the bar code may be a proprietary bar code other than a UPC code. In this case, the proprietary bar code may only be decodable by the entity that owns the symbology and has distributed the codes. Since in the first embodiment above, UPC databases are commercially available, the online auction service need not rely on an external gateway to decode and resolve the bar code. In this case, however, the online auction server computer would be unable to decode the proprietary code, so it is sent directly from the mobile device to the gateway server computer. In an alternative embodiment, the code may be always sent from the mobile device to the online auction server computer, which would either (1) decode the bar code internally using a commercially available database (e.g. UPCs), or (2) send a request to the gateway server computer in the event it cannot interpret the bar code data internally (e.g. a proprietary code).

Once the gateway server has received a request to (decode and) resolve the bar code data, it first analyzes the code to determine which third party is associated with the bar code data (i.e. owns the code). Once it determines where to send the code, it will send a request to resolution server computer determined to be associated with the bar code data. The selected resolution server receives the bar code data from the gateway server computer and resolves the bar code data to a URL associated with the product. For example, a proprietary bar code found on a pair of NIKE sneakers might resolve to

http://www.nike.com/jordans-new-sneakers.html

The resolution server computer then transmits the URL to the gateway server computer, which returns the URL to the mobile device (either directly or via the online auction server computer). The mobile device then executes an online auction application to use the URL to query the online auction server computer for information associated with the product (as obtained from the URL) that was described above.

In the second manner of processing the bar code data, the gateway server computer resolves the bar code data internally to a URL associated with the product without reliance on an external service. This may done if the lookup database for the code is stored locally at the gateway server, such as by caching or the like.

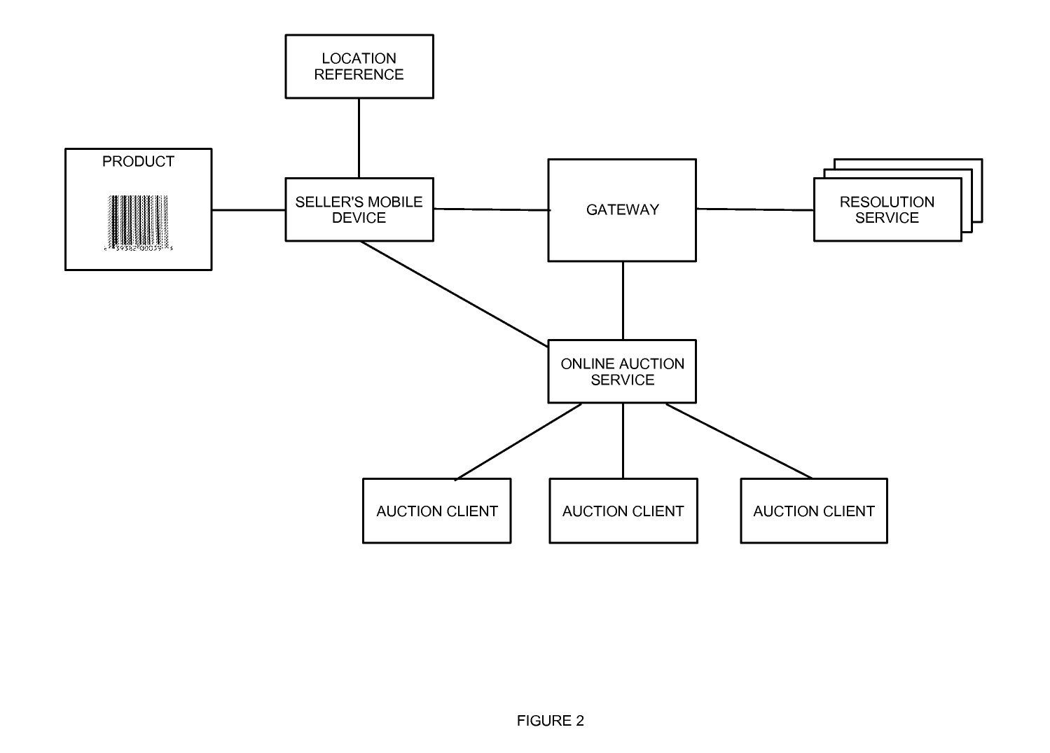

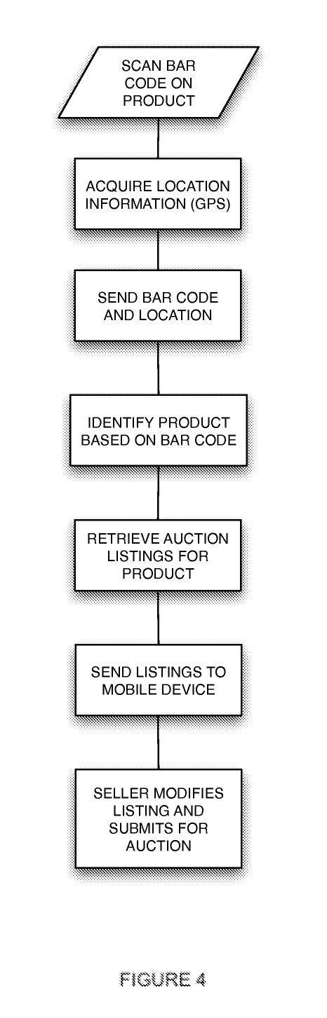

In a second aspect of the invention, with respect to FIGS. 2 and 4, a user desires to sell a product via an online auction service. In order to generate an online auction listing for that product, the seller uses a mobile device to capture an image of a bar code symbol associated with a product he desires to sell in an online auction. The bar code may be found on the product itself, or on its packaging, or on an advertisement of the product, etc. Typically the bar code would be a UPC code prevalent in commerce today, although this invention may be adapted to work with any type of bar code that can be imaged and decoded with the mobile device running appropriate software as well known in the art.

The mobile device also acquires location information from a location reference (such as GPS as described above), the location information indicative of the location of the mobile device. The mobile device transmits the bar code data from the captured image of the bar code symbol and the location information to an online auction server computer. The online auction server computer processes the bar code data to identify the product. The bar code data may be decoded on the mobile device, or it may be sent in an undecoded format to the online auction server computer for decoding thereon as well known in the art. The online auction server computer may be operated by an online auction company such as EBAY or the like.

The online auction server computer processes the bar code data to determine the identification of the product that was scanned by the purchaser. This may be done by using a simple lookup table commonly used in commerce, where the UPC code is used to retrieve information about the associated product (such as price, description, manufacturer, etc.). This type of database is commercially available and may be located internal to the online auction server computer or it may be accessed via a network connection.

The online auction server computer may have a set of predetermined listings stored in memory that are associated with various products. The predetermined listing information may state, for example, a detailed description of the product, its specifications, a basic price, images of the product, etc. The online auction server computer will retrieve the predetermined listing for the particular product scanned by the seller, and then return to the mobile device the predetermined listing information associated with the product.

The mobile device uses the predetermined listing information associated with the product to generate an online auction listing for the product, which includes the product location information as derived from the GPS information of the mobile device. The seller may optionally modify the predetermined information in the online auction listing, such as by changing the price, etc. The mobile device then transmits the online auction listing for the product back to the online auction server computer, and the online auction server computer operates an online auction in association with a plurality of auction client computers that bid for the purchase of the product from the seller in accordance with the online auction listing generated by the mobile device.

So, for example, if the seller wants to sell his Blu-Ray DVD of THE MATRIX, he would scan the bar code (a UPC) found on the back of the DVD case. The UPC data would be sent to the online auction server computer, which would decode the data and look up a preconfigured listing that would describe the DVD in detail. That listing would be sent back to the mobile device, where the user could enter his desired price, such as $50. The modified auction listing would be sent back to the online auction server computer, which would in turn initiate an online auction accordingly. This eliminates the need for the seller to manually enter listing information for the product being sold.

In an alternative embodiment, a gateway service is used to help mediate the identification of the product from the bar code information rather than using a UPC lookup at the online auction server computer. In this embodiment, the seller uses a mobile device to capture an image of a bar code symbol associated with a product the seller desires to sell in an online auction. The mobile device also acquires location information from a location reference, the location information indicative of the location of the mobile device. The mobile device transmits bar code data from the captured image of the bar code symbol to a gateway server computer. The gateway server computer processes the bar code data and returns to the mobile device a URL associated with the product. The URL may be obtained in one of two possible ways as described below. The mobile device executes an online auction application to use the URL to query an online auction server computer for predetermined information associated with the product. The mobile device uses the predetermined information associated with the product to generate an online auction listing for the product, the online product listing including the product location information. The seller may optionally modify the predetermined information in the online auction listing. The mobile device transmits the online auction listing for the product to the online auction server computer, and the online auction server computer operates an online auction in association with a plurality of auction client computers that bid for the purchase of the product from the seller in accordance with the online auction listing generated by the mobile device.

As stated above, the gateway server computer processes the bar code data in one of two possible ways. First, the gateway server computer may use an external resolution service by analyzing the bar code data to determine which of a plurality of resolution server computers is associated with the bar code data. That is, the bar code may be a proprietary bar code other than a UPC code. In this case, the proprietary bar code may only be decodable by the entity that owns the symbology and has distributed the codes. Since in the first embodiment above, UPC databases are commercially available, the online auction service need not rely on an external gateway to decode and resolve the bar code. In this case, however, the online auction server computer would be unable to decode the proprietary code, so it is sent directly from the mobile device to the gateway server computer. In an alternative embodiment, the code may be always sent from the mobile device to the online auction server computer, which would either (1) decode the bar code internally using a commercially available database (e.g. UPCs), or (2) send a request to the gateway server computer in the event it cannot interpret the bar code data internally (e.g. a proprietary code).

Once the gateway server has received a request to (decode and) resolve the bar code data, it first analyzes the code to determine which third party is associated with the bar code data (i.e. owns the code). Once it determines where to send the code, it will send a request to resolution server computer determined to be associated with the bar code data. The selected resolution server receives the bar code data from the gateway server computer and resolves the bar code data to a URL associated with the product. For example, a proprietary bar code found on a pair of NIKE sneakers might resolve to

http://www.nike.com/jordans-new-sneakers.html

The resolution server computer then transmits the URL to the gateway server computer, which returns the URL to the online auction server computer or the mobile device in order to obtain the predetermined information associated with the product to generate an online auction listing for the product as described above. In the second manner of processing the bar code data, the gateway server computer resolves the bar code data internally to a URL associated with the product without reliance on an external service.

What is claimed is:

1. A method of providing a mobile shopping platform comprising:
a. a purchaser using a mobile device to capture an image of a bar code symbol associated with a product the purchaser desires to purchase;
b. the mobile device acquiring location information from a location reference, said location information indicative of the location of the mobile device;
c. the mobile device transmitting bar code data from the captured image of the bar code symbol and the location information to an online auction server computer;
d. the online auction server computer processing the bar code data to identify the product and returning to the mobile device information associated with the product, said information comprising one or more of:
(i) a list of online auctions for the product or a similar product;
(ii) a list of commercial web sites in which the product or a similar product is being offered for sale; and/or
(iii) a list of resellers of the product or a similar product;
where the product or similar product is located in a geographic region in predetermined proximity to the location;
e. the mobile device displaying to the purchaser the information received from the online auction server computer.

2. The method of claim 1 comprising the further step of executing additional searches of the product or a similar product using the information returned from the online auction server computer.

3. The method of claim 1 comprising the further step of the purchaser executing a purchase transaction using the information returned from the online auction server computer.

4. A method of providing a mobile shopping platform comprising:
a. a purchaser using a mobile device to capture an image of a bar code symbol associated with a product the purchaser desires to purchase;
b. the mobile device acquiring location information from a location reference, said location information indicative of the location of the mobile device;
c. the mobile device transmitting bar code data from the captured image of the bar code symbol and the location information to a gateway server computer;
d. the gateway server computer processing the bar code data and returning to the mobile device a URL associated with the product;
e. the mobile device executing an online auction application to use the URL to query an online auction server computer for information associated with the product, said information comprising one or more of:
(i) a list of online auctions for the product or a similar product;
(ii) a list of commercial web sites in which the product or a similar product is being offered for sale; and/or
(iii) a list of resellers of the product or a similar product;
where the product or similar product is located in a geographic region in predetermined proximity to the location; and
f. the mobile device displaying to the purchaser the information received from the online auction server computer.

5. The method of claim 4 wherein the step of the gateway server computer processing the bar code data comprises:
analyzing the bar code data to determine which of a plurality of resolution server computers is associated with the bar code data;
the gateway server computer transmitting the bar code data to resolution server computer determined to be associated with the bar code data;
the resolution server receiving the bar code data from the gateway server computer and resolving the bar code data to a URL associated with the product; and
the resolution server computer transmitting the URL to the gateway server computer.

6. The method of claim 4 wherein the step of the gateway server computer processing the bar code data comprises resolving internally the bar code data to a URL associated with the product.

7. The method of claim 4 comprising the further step of the purchaser executing a purchase transaction using the information returned from the online auction server computer.

8. A method of generating a product listing for an online auction comprising:
a. a seller using a mobile device to capture an image of a bar code symbol associated with a product the seller desires to sell in an online auction;
b. the mobile device acquiring location information from a location reference, said location information indicative of the location of the mobile device;
c. the mobile device transmitting bar code data from the captured image of the bar code symbol and the location information to an online auction server computer;
d. the online auction server computer processing the bar code data to identify the product and returning to the mobile device predetermined listing information associated with the product;
e. the mobile device using the predetermined listing information associated with the product to generate an online auction listing for the product, said online product listing including the product location information;
f. the seller optionally modifying the predetermined information in the online auction listing;
g. the mobile device transmitting the online auction listing for the product to the online auction server computer; and
h. the online auction server computer operating an online auction in association with a plurality of auction client computers that bid for the purchase of the product from the seller in accordance with the online auction listing generated by the mobile device.

9. A method of generating a product listing for an online auction comprising:
a. a seller using a mobile device to capture an image of a bar code symbol associated with a product the seller desires to sell in an online auction;
b. the mobile device acquiring location information from a location reference, said location information indicative of the location of the mobile device ;
c. the mobile device transmitting bar code data from the captured image of the bar code symbol to a gateway server computer;
d. the gateway server computer processing the bar code data and returning to the mobile device a URL associated with the product;
e. the mobile device executing an online auction application to use the URL to query an online auction server computer for predetermined information associated with the product;
f. the mobile device using predetermined information associated with the product to generate an online auction listing for the product, said online product listing including the product location information;
g. the seller optionally modifying the predetermined information in the online auction listing;
h. the mobile device transmitting the online auction listing for the product to the online auction server computer; and
i. the online auction server computer operating an online auction in association with a plurality of auction client computers that bid for the purchase of the product from the seller in accordance with the online auction listing generated by the mobile device.

10. The method of claim 9 wherein the step of the gateway server computer processing the bar code data comprises
analyzing the bar code data to determine which of a plurality of resolution server computers is associated with the bar code data;
the gateway server computer transmitting the bar code data to the resolution server computer determined to be associated with the bar code data;
the resolution server receiving the bar code data from the gateway server computer and resolving the bar code data to a URL associated with the product; and
the resolution server computer transmitting the URL to the gateway server computer.

11. The method of claim 9 wherein the step of the gateway server computer processing the bar code data comprises resolving internally the bar code data to a URL associated with the product.
